(19) United States
(12) Patent Application Publication
(10) Pub. No.: US 2008/0089650 A1
(43) Pub. Date: Apr. 17, 2008

(54) FIBER OPTIC CONNECTOR

(75) Inventors: STEWART LEGLER, MCKINNEY, TX (US); BRYAN CULL, ALLEN, TX (US); CAMERON TAYLOR, PRINCETON, TX (US); DEREK BRENT VINSON, FRISCO, TX (US)

Correspondence Address: HOWISON & ARNOTT, L.L.P, P.O. BOX 741715, DALLAS, TX, 75374-1715, US

(73) Assignee: FIBER SYSTEMS INTERNATIONAL D/B/A AMPHENOL FIBER SYSTEMS INTERNATIONAL, ALLEN, TX (US)

(21) Appl. No.: 11/750,844

(22) Filed: May 18, 2007

Related U.S. Application Data
(60) Provisional application No. 60/808,476, filed on May 24, 2006.

(51) Int. Cl. G02B 6/38

(52) U.S. Cl. 385/59

(57) ABSTRACT

A fiber optic connector for mounting to a cable having a plurality of optical fibers and optically connecting the optical fibers to mating optical fibers, wherein the optical fibers and the mating optical fibers have termini mounted to respective ends thereof. The connector comprises a generally cylindrical plug body, a plug insert and a biasing member. The plug body has a longitudinal axis, a wall defining a central longitudinal passage, and a circumferential groove formed on the outer surface of the wall dimensioned to receive portions of a U-shaped securing staple. The plug insert has a front face and is longitudinally slidably disposed within a first portion of the longitudinal passage for longitudinal movement between an extended position and a compressed position. The insert defines a plurality of termini cavities formed longitudinally through the front face for mounting a plurality of the termini of the optical fibers therein. The biasing member is disposed between the plug body and plug insert for urging the plug insert longitudinally toward the extended position.

### CROSS-REFERENCE TO RELATED APPLICATIONS

This application claims the benefit of U.S. Provisional Application Ser. No. 60/808,476 filed May 24, 2006 entitled FIBER OPTIC CONNECTOR, the disclosure of which is incorporated herein for all purposes.

### TECHNICAL FIELD

The subject disclosure relates to the field of fiber optic connectors, and more particularly to fiber optic connectors having plug and receptacle portions operationally secured together using a hydraulic-style staple-lock connector mechanism.

### BACKGROUND

The typical fiber optic connector includes a plug for mounting fiber optic termini sockets and a mating receptacle for mounting fiber optic termini pins. Each respective optical termini socket or pin is, in turn, operatively connected to an optical fiber extending from the respective plug/receptacle. In so-called hybrid connectors, the plug may also house electrical contact sockets and the receptacle may also house electrical contact pins, with each contact being operatively connected to a wire or other electrical conductor extending from the plug/receptacle. A plug insert and a receptacle insert are usually disposed within the respective plug/receptacle for securing and arranging the individual termini/contact sockets and pins. When the plug is operationally engaged with the receptacle, the termini/contact sockets are brought into physical contact with matching termini/contact pins to allow transmission of optical signals across the termini (and electrical signals and/or power across the contacts, if present).

It is known to mount the optical termini sockets/pins using springs in longitudinal cavities formed in the respective inserts. These springs allow the sockets/pins to move longitudinally a short distance within the cavity to accommodate the dimensional variation caused by cumulative manufacturing tolerances (sometimes referred to as the “tolerance stack”) present in the components of the plug and receptacle. This movement allows the sockets/pins to remain in contact without being overstressed, provided the tolerance stack does not exceed the movement limits (i.e., “travel”) of the termini/contacts. A variety of spring-loaded termini assemblies having standardized dimensions are available commercially as “off-the-shelf” items. Each standardized assembly typically has a predetermined amount of socket/pin travel provided by the spring-loading.

It is known in the mining industry to use a connector assembly form known as a “staple-lock” connector. Although originally designed for hydraulic connectors, the staple-lock connector is now used for a variety of connection applications, including hydraulic lines, electrical cables, shield-wall connectivity, mine communications and environmental sensing devices. Staple-lock connectors include a generally cylindrical plug member dimensioned for insertion into a matching cylindrical cavity formed in a receptacle member. An outer cylindrical groove is formed on the outer surface of the plug member, and an inner cylindrical groove is formed on the inner surface of the receptacle cavity. At least two holes are formed in the wall of the receptacle at the location of the inner cylindrical groove. The plug and receptacle may be releaseably secured by first inserting the plug into the receptacle cavity until the inner and outer grooves are aligned, and then forcing (typically by hammering) a U-shaped staple through the holes such that it substantially fills adjacent portions of both grooves, thereby holding them in rigid alignment. The plug and receptacle may be released by removing the staple using a suitable tool. Mining personnel are typically familiar with the use and operation of staple-lock connectors, and have ready access to the appropriate tools and staples.

As fiber optics are increasingly used in the mining industry, a need exists for a fiber optic connector having a staple-lock form that is familiar to mining personnel. A need further exists, for a staple-lock type fiber optic connector that may be used with “off-the-shelf” termini and contact assemblies. However, one significant characteristic of the staple-lock type of connector (at least, as used in the mining industry) is that the dimensional tolerances are relatively high (i.e., producing large variations in the dimensions of the connector after connection with the staple) as compared to precision connectors of the type typically used for optical fiber connectors. This large tolerance is due to many factors, including dimensional variation among the staples due to: different manufacturers, slightly different designs, and wear and tear. The tolerance stack in a typical staple-lock type of connector, as used in the mining industry, will often exceed the travel of the “off-the-shelf” fiber optic termini.

Another difference between connectors used in the mining industry and many other applications is vibration. Connectors used in the mining industry may be subjected to severe and continuous vibrations. Staple lock type connectors for hydraulic and electrical connections are used, at least in part, to prevent such couplings from vibrating loose. However, the dimensional tolerances involved with the use of staple lock type connector may exceed the amount of travel afforded by spring loaded termini. Vibrations encountered in mining applications may result in movement of the connector that tends to cause the terminal ends of the termini to separate, thereby interfering with or cutting off signal transmissions. Thus, a need exists for a staple-lock type fiber optic connector that accommodates tolerance stacks in excess of the travel provided by the termini and contact assemblies. Put another way, a need exists, for a staple-lock type fiber optic connector that establishes and maintains connection between spring-loaded termini/contacts at a substantially constant force, even when the longitudinal travel between the connector members exceeds the longitudinal travel of the spring-loaded termini/contact and/or when the connector is subject to vibration.

### SUMMARY

In one aspect, a fiber optic connector comprises a fiber optic connector for mounting to a cable having a plurality of optical fibers and optically connecting the optical fibers to mating optical fibers, wherein the optical fibers and the mating optical fibers have termini mounted to respective ends thereof, and wherein the termini of at least one of the optical fibers and the mating optical fibers are slidably mounted and biased to provide a predetermined amount of longitudinal travel during connection. The fiber optic connector comprises a generally cylindrical plug body, a plug insert and a biasing member. The plug body has a longitudinal axis, a wall defining a central longitudinal passage, and a circumferential groove formed on the outer surface of the wall dimensioned to receive portions of a U-shaped securing staple. The plug insert has a front face and is longitudinally slidably disposed within a first portion of the longitudinal passage for longitudinal movement between an extended position and a compressed position. The insert defines a plurality of termini cavities formed longitudinally through the front face for mounting a plurality of the termini of the optical fibers therein. The biasing member is disposed between the plug body and plug insert for urging the plug insert longitudinally toward the extended position.

The end of the plug body proximate to the front face of the plug insert is longitudinally inserted into a receiving cavity of a receptacle body mounting the mating optical fibers in a receptacle insert having a front face until the front face of the plug insert abuts the front face of the receptacle insert. The plug insert moves longitudinally against the urging of the biasing member to accommodate relative movement between the plug body and the receptacle body while maintaining fixed contact between the front face of the plug insert and the front face of the receptacle insert as the circumferential groove is longitudinally aligned with a plurality of holes formed through the receptacle body. In this manner, operational contact between the termini of the optical fibers and the mating optical fibers is maintained at a substantially constant force when the legs of a U-shaped staple are inserted through the holes to occupy portions of the groove to secure the plug body in the receptacle.

In one variation, the plug insert including the termini cavities is formed by injection molding and the plurality of termini cavities formed longitudinally through the plug insert comprise a single, central termini cavity surrounded by a plurality of circumferentially arranged, equally spaced-apart outer termini cavities. In another aspect, the minimum wall thickness between the central termini cavity and the outer termini cavities is approximately equal to the minimum wall thickness between adjacent outer termini cavities. In one variation, the plug insert may be formed of a glass-filled polymer resin containing from about 25% to about 45% glass.

In one variation, the plug body and receptacle are produced from a metal such as brass or stainless steel.

In one embodiment, a fiber optic connector is configured for mounting to a cable having a plurality of optical fibers and optically connecting the optical fibers to mating optical fibers. The optical fibers and the mating optical fibers have termini mounted to respective ends thereof, and at least one of the termini is slidably mounted and biased to provide a predetermined amount of longitudinal travel during connection. The connector includes a plug body having a groove formed on the outer surface thereof and an insert slidably disposed within the plug body, the insert defining a plurality of termini cavities formed longitudinally therethrough for mounting a plurality of the termini of the optical fibers therein.

A biasing member is disposed around an outside surface of the insert to act on and against the plug body to bias the insert toward an extended position. The biasing member is compressed upon insertion of the plug body into a receptacle such that the insert is pressed against a corresponding mating insert in the receptacle to maintain contact between termini mounted in the insert and the mating insert when the plug body is secured in the receptacle with a staple extending through the receptacle and the groove.

In one variation, the insert includes a large diameter forward end and a smaller diameter rear end slidably disposed in the plug body. The biasing member is disposed in a groove formed in the forward end of the plug body in opposing relationship with the large diameter forward end of the insert. The biasing member may be a compression spring or a similar resilient body.

In another embodiment, a connector assembly is configured for mounting to a cable having a plurality of optical fibers and optically connecting the optical fibers to mating optical fibers. The optical fibers and the mating optical fibers have termini mounted to respective ends thereof, and at least one of the termini is slidably mounted and biased to provide a predetermined amount of longitudinal travel during connection.

The assembly includes an insert adapted for slidably mounting in a plug body of the connector.

A plurality of termini cavities extend through the plug body and are arranged to receive the mating termini of a receptacle. A biasing member biases the insert against the plug body for limited longitudinal movement of the insert between an extended position and a compressed position when the insert is pressed against a surface of a corresponding receptacle. The insert moves rearwardly against the force exerted by the biasing member when the insert is pressed against a corresponding mating insert in the receptacle to maintain contact between termini mounted in the insert and in the receptacle.

In one variation, the insert of the assembly includes a large diameter forward end and a smaller diameter rear end and the biasing member comprises a compression spring disposed around an outer perimeter of the smaller diameter rear end. The biasing member may be disposed in a groove formed in the forward end of the plug body in opposing relationship with the large diameter forward end of the insert.

In one variation, a plurality of sleeves are disposed in the termini cavities for alignment of the termini. The sleeves may be split sleeves formed from a ceramic material.

In yet another variation, a connector assembly for mounting to a cable having a plurality of optical fibers and optically connecting the optical fibers to mating optical fibers includes an insert having a plurality of termini cavities extending therethough. The termini cavities are arranged to receive the mating termini of a fiber optic connector wherein at least one of the mating termini is slidably mounted and biased to provide a predetermined amount of longitudinal travel during connection. A biasing member extends around an outer perimeter of the insert for biasing the insert for limited longitudinal movement of the insert between an extended position and a compressed position when the insert is pressed against a surface of a corresponding connector. A plurality of ceramic sleeves are disposed in the termini cavity for aligning termini disposed therein with the mating termini. The biasing member maintains the insert in contact with a surface of a corresponding connector when the insert is pressed against the corresponding connector to maintain contact between termini mounted in the insert and the mating termini.

In one variation, the plurality of termini cavities formed longitudinally through the plug insert comprise a single, central termini cavity surrounded by a plurality of circumferentially arranged, equally spaced-apart outer termini cavities. In this regard, the minimum wall thickness between the central termini cavity and the outer termini cavities may be approximately equal to the minimum wall thickness between adjacent outer termini cavities.

In another aspect thereof, the fiber optic connector comprises an electrical connector for mounting to a cable having a plurality of electrical conductors and electrically connecting the electrical conductors to mating electrical conductors, wherein the electrical conductors and the mating electrical conductors have contacts mounted to respective ends thereof. The electrical connector comprises a generally cylindrical plug body, a plug insert and a biasing member. The plug body has a longitudinal axis, a wall defining a central longitudinal passage, and a circumferential groove formed on the outer surface of the wall dimensioned to receive portions of a U-shaped securing staple. The plug insert has a front face, and the plug insert is longitudinally slidably disposed within a first portion of the longitudinal passage for longitudinal movement between an extended position and a compressed position. The insert defines a plurality of contact cavities formed longitudinally through the front face for mounting a plurality of the contacts of the electrical conductors therein. The biasing member is disposed between the plug body and plug insert for urging the plug insert longitudinally toward the extended position.

### BRIEF DESCRIPTION OF THE DRAWINGS

For a more complete understanding, reference is made to the drawings, wherein like reference numbers are used herein to designate like elements throughout, and wherein:

FIGS. 1 and 2 are sectional views of a prior art plug assembly and socket assembly;

FIG. 3 is a sectional view of the prior art plug and socket of FIGS. 1 and 2 coupled together;

FIG. 4 is a perspective view of a coupled plug and socket assembly as described herein;

FIG. 5 is a partial sectional and partial cut away view of the plug and socket assembly of FIG. 4;

FIG. 6 is a partial cut away view of the plug and socket assembly of FIG. 4;

FIG. 7 is an exploded view of the plug and socket assembly of FIG. 4;

FIG. 8a is a perspective view of the plug insert of FIG. 4;

FIG. 8b is front view of the plug insert of FIG. 8a;

FIG. 8c is front view of the plug insert of FIG. 8a positioned in a plug body;

FIG. 9a is a perspective view of the socket insert of FIG. 4;

FIG. 9b is a front view of the socket insert of FIG. 9a;

FIG. 9c is a front view of the socket insert of FIG. 9a positioned in a receptacle;

FIG. 10 is a front perspective view of a plug and through-wall socket assembly as described herein;

FIG. 11 is a rear perspective view of the plug and through-wall socket assembly of FIG. 10;

FIG. 12 is a partial sectional and partial cutaway view of the plug and through-wall socket assembly of FIG. 10; and

FIG. 12A is an enlarged portion of FIG. 12 designated 12a in FIG. 12.

### DETAILED DESCRIPTION

Referring now to the drawings, wherein like reference numbers are used herein to designate like elements throughout the various views, embodiments of the connector are illustrated and described, and other possible embodiments of the fiber optic connector are described. The figures are not necessarily drawn to scale, and in some instances the drawings have been exaggerated and/or simplified in places for illustrative purposes only. One of ordinary skill in the art will appreciate the many possible applications and variations of the disclosure based on the following examples of possible embodiments.

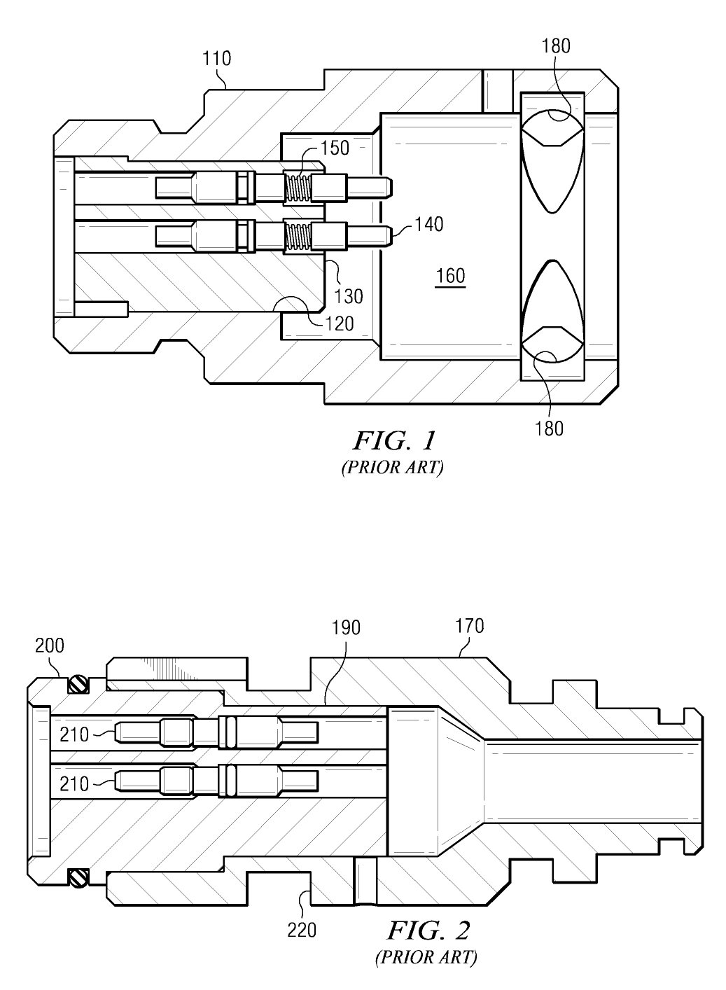

Referring to FIGS. 1-3, there is illustrated a prior art connector assembly 100 of the staple-lock type including a receptacle 110 and plug 170. As best illustrated in FIG. 1, receptacle 100 has a longitudinally extending central opening 120 for receiving a receptacle insert 130 therein. Receptacle insert 130 is locked in position in opening 120 of receptacle 110. One or more termini 140 are slidably mounted in plug insert 130 and forwardly biased with springs 150, permitting travel of the termini over a predetermined distance in a rearward direction. Termini 140 are configured to mount the terminal end of an optical fiber for mating with a corresponding optical fiber of a plug. Receptacle 110 includes a forwardly opening socket 160 for receiving a corresponding plug 170 and a plurality of holes 180 for receiving a U-shaped staple formed through the wall of the socket.

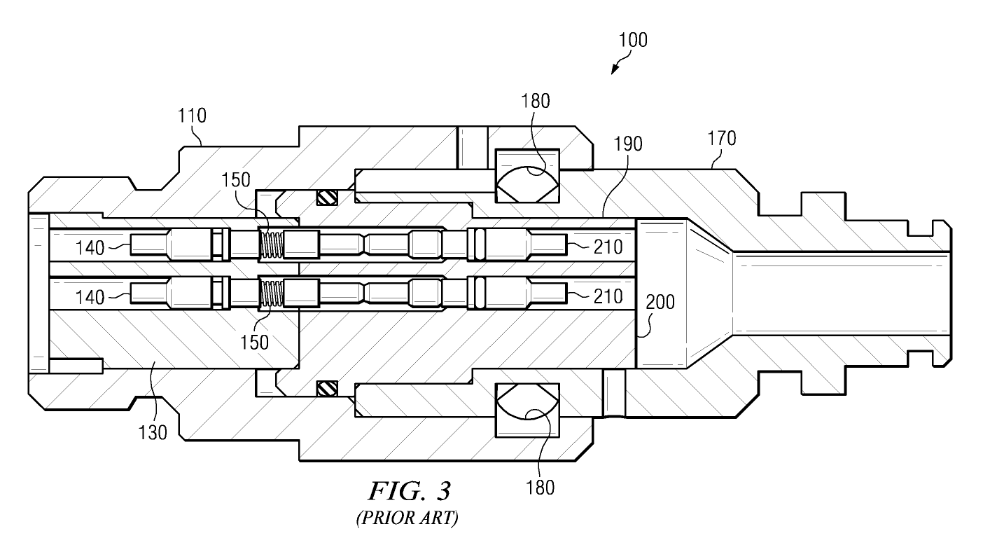

As best shown in FIG. 2, plug 170 includes a central longitudinal opening 190 for receiving a plug insert 200 having one or more mating termini 210 mounted therein. As in the case of receptacle insert 130 of receptacle 110, plug insert 200 of plug 170 is locked in position in the plug. Plug 170 is configured for insertion into socket 160 with mating termini 210 aligned with termini 140 of receptacle 110. A circumferential groove 220 formed around the outside of plug 170 is positioned for alignment with holes 180 of socket 160. As best illustrated in FIG. 3, when plug 170 is inserted in socket 160, the terminal ends of mating termini 210 are pushed against the terminal ends of termini 140, forcing termini 140 to move rearwardly against springs 150. A U-shaped staple (not shown) inserted into holes 180 passes through circumferential groove 220, locking plug 170 in receptacle 110.

Biasing slidably mounted termini 140 with springs 150 is required to maintain the terminal ends of termini 140 in operational contact with the terminal ends of mating termini 210 such that light traveling through optical fibers connected to termini 140 is transmitted to corresponding optical fibers connected to termini 210. However, if the tolerance stack of the connector assembly 100 exceeds the travel permitted by the spring-loaded termini 140, a connection failure may occur. Too little travel may result in inadequate surface contact between the terminal ends of termini 140 and termini 210. Too much travel may result in excessive contact force as plug 170 is inserted in receptacle 110 and the securing staple is forced into place.

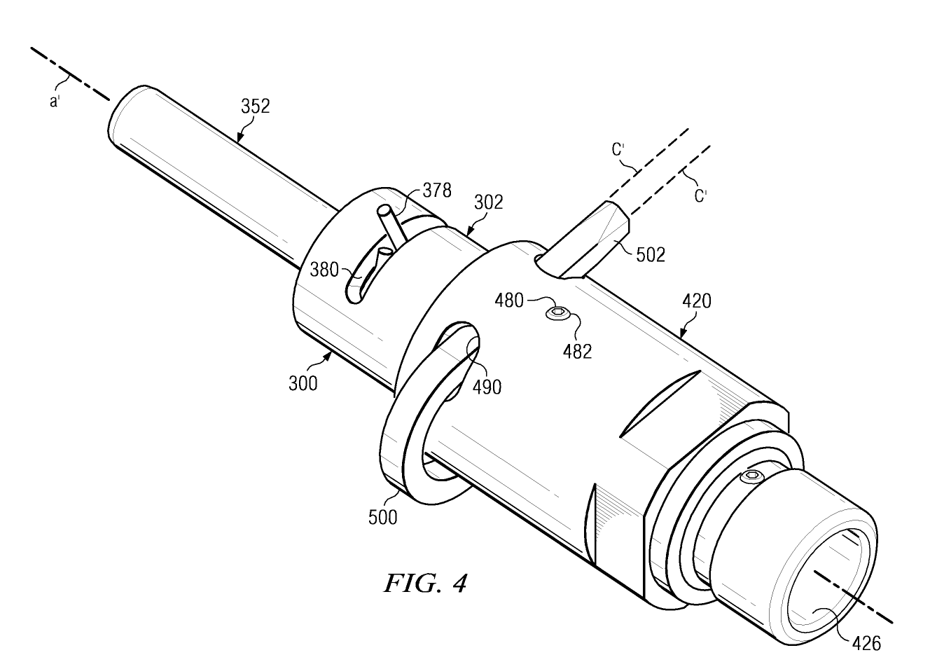

Turning to FIGS. 4-7, a connector 300 for mounting a cable having a plurality of optical fibers and optically connecting the fibers to mating optical fibers includes a generally cylindrical plug body 302 having a longitudinal axis and a wall 304 defining a central longitudinal passage 306 through the plug body. Plug body 302 is typically formed from a metal such as brass or stainless steel for use in mining industry applications. A plug insert 308 includes a cylindrical rear section 314 slidably disposed in a front portion of passage 306 and an enlarged front end 310 having a front face 312. A rearwardly facing wall 316 extends radially from rear section 314 to the outside surface of enlarged front end 310 of plug insert 306.

A bearing washer 320 and a biasing member 322 are circumferentially disposed around rear section 314 of plug insert 308 between wall 316 and the forward end 324 of plug body 302. In one variation, biasing member 322 comprises a Wavo-type spring seated in an annular groove 328 in the forward end 324 of plug body 302; however, other known compression type springs and resilient compressible members may be utilized. Biasing member 322 biases plug insert 308 in the forward direction relative to plug body 302 such that the plug insert is slidable relative to the plug body between an extended or forward position wherein biasing member 322 is relatively less compressed and a retracted or rearward position wherein member 322 is relatively more compressed between wall 316 and the forward end 324 of plug body 302. Biasing member 322 preferably provides a substantially constant biasing force throughout the travel of plug insert 308 between the extended and retracted positions

Plug insert 308 includes a slot 330 formed in the outer surface of rear section 314 of the insert. A set screw 332 extending through a radially extending threaded opening 334 in wall 304 of plug body 302 engages slot 330 to retain insert 308 in plug body 302. Slot 330 is sufficiently long to permit movement of insert 308 between the forward position and the rear position wherein biasing member 322 is compressed. Set screw 332 is tightened into opening 334 only to the extent necessary to engage slot 330 without interfering with the movement of plug insert 308 relative to plug body 302. An O-ring 326 is positioned in an annular groove 336 formed in the inside surface of wall 304 of plug body 302 rearward of opening 334. O-ring 326 provides an environment seal between plug insert 308 and plug body 302.

Plug insert 308 includes a plurality of termini cavities 340 formed longitudinally through front face 312 of the insert for mounting a plurality of termini 342 therein. Termini 342 are mounted in cavities 340 with the terminal ends of the termini positioned rearward of front face 312. In the illustrated embodiment, a plurality of termini cavities 340 are positioned in a circular pattern around a centrally located cavity 340a; however, other configurations of the termini cavity are possible. A circumferential groove 344 formed in the outside surface of enlarged diameter front end 310 of insert 308 receives an O-ring 346 that seals between the insert and a receptacle 420.

Central longitudinal passage 306 of plug body 302 includes an enlarged, rearwardly opening hole 350 for receiving the forward end 354 of a cable guide 352 therein. Cable guide 352 includes a cylindrical wall 356 defining an axially extending conduit 358 for receiving a fiber optic cable. The forward end of cable guide 352 and the rearmost end of plug insert 308 are spaced apart in longitudinal passage 306 to form a chamber 362 (sometimes called an “S-ing” chamber) wherein optical fibers entering plug body 302 may flex by forming an “S” shape over the length of the chamber. Conduit 358, chamber 362 and termini cavities 40 define a plurality of fiber paths 364 along which optical fibers are guided into plug body 302 and termini 342.

The forward end of cable guide 352 includes a pair of circumferential grooves 366, 368 formed in the outside surface of the guide. An O-ring 372 is seated in forward groove 366 to provide a seal between the cable guide and the inside surface of wall 304 of plug body 302. Rear groove 368 is longitudinally aligned with a corresponding circumferential groove 374 formed on the inside surface of wall 304 of plug body 302 to provide an annular space 376 for receiving a retaining clip 378. Retaining clip 378 is inserted through a slot 380 formed in plug body 302 into annular space 376 to retain cable guide 352 in plug body 302.

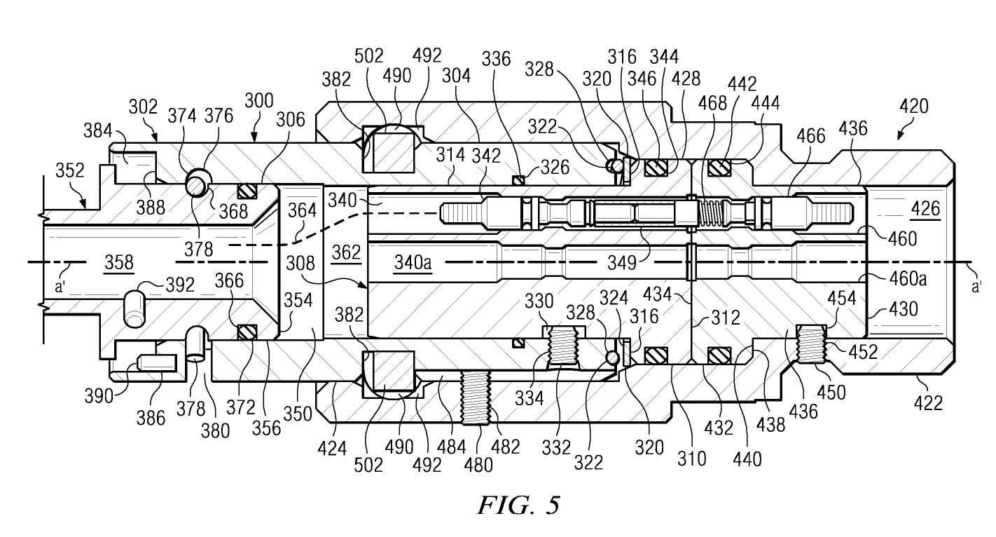

As best illustrated in FIG. 5, plug body 302 includes an annular recess 384 extending forward from the rearmost end of the body. An axially extending hole 386 formed in the forward wall 388 of recess 384 receives an anti-rotation pin 390. Anti-rotation pin 390 engages a second anti-rotation pin 392 extending radially from wall 356 of cable guide 352 to prevent rotation of the cable guide over more than 360 degrees relative to plug body 302. Anti-rotation pins 390, 392 prevent a fiber optic cable engaged in cable guide 352 from being twisted to the extent that optical fibers in the cable may be broken or damaged.

Referring still to FIGS. 4-7, a receptacle 420 for receiving connector 300 includes a cylindrical wall 422 defining a forwardly opening socket 424 and a rearwardly opening passage 426 for receiving a fiber optic cable therein. As in the case of plug body 302, socket 424 is typically formed from a metal such as brass or stainless steel. A cylindrical cavity 428 extends between socket 424 and passage 426. A socket insert 430 includes an enlarged forward section 432 having a forward mating face 434, a rear portion 436 and a wall 438 extending radially between rear portion 436 and forward section 432. Insert 430 is positioned in receptacle 420 with enlarged forward portion in cavity 428 and rear portion 436 extending into passage 426 and wall 438 abutting a corresponding wall 440 extending radially between passage 426 and cavity 428. An O-ring 442 positioned in an annular groove 444 formed in the outside surface of forward section 432 of insert 430 seals between the insert the inside surface of cavity 428. Insert 430 is retained in receptacle 420 by means of a set screw 450 that passes through a threaded aperture 452 in wall 422 to engage a recess 454 formed in the outside surface of rear portion 436 of the insert.

Socket insert 430 includes a plurality of termini cavities 460 formed longitudinally through front face 434 of the insert for mounting a plurality of termini 466 therein. Termini 466 are mounted in cavities 460 with the terminal ends of the termini extending forward from front face 434. In the illustrated embodiment, termini cavities 460 are positioned in a circular pattern around a centrally located cavity 460a corresponding to the pattern of cavities 340 and 340a of connector 300. One or more of termini 466 are provided with a biasing element such as spring 468 that biases the terminus in a forward direction and permits the terminus to move rearwardly against the spring over a predetermined distance.

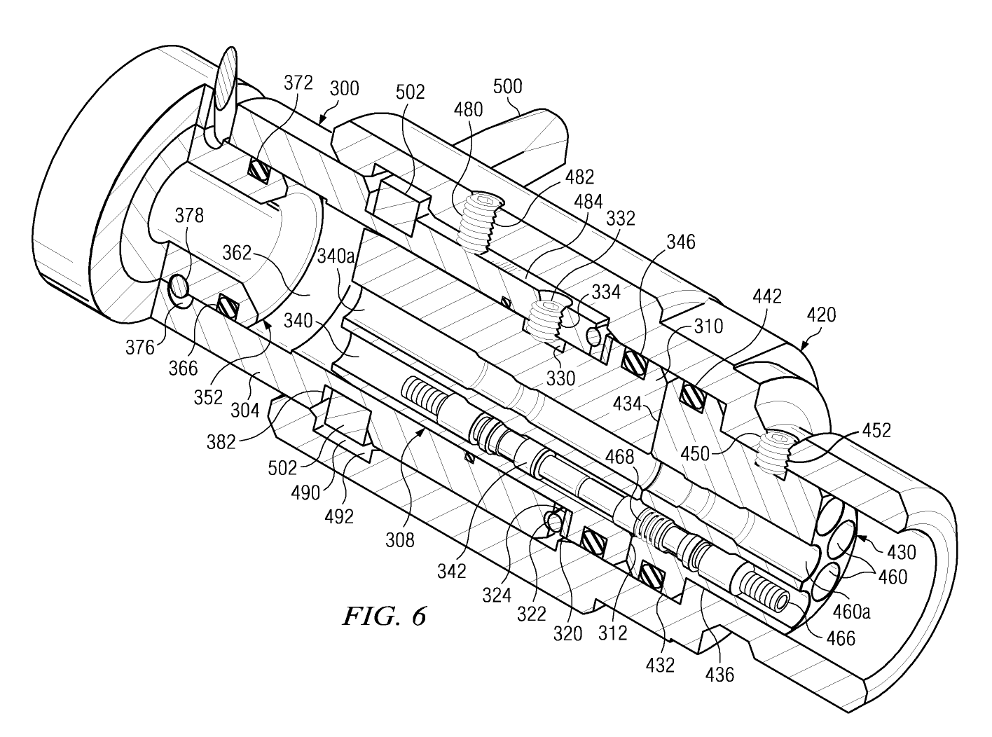

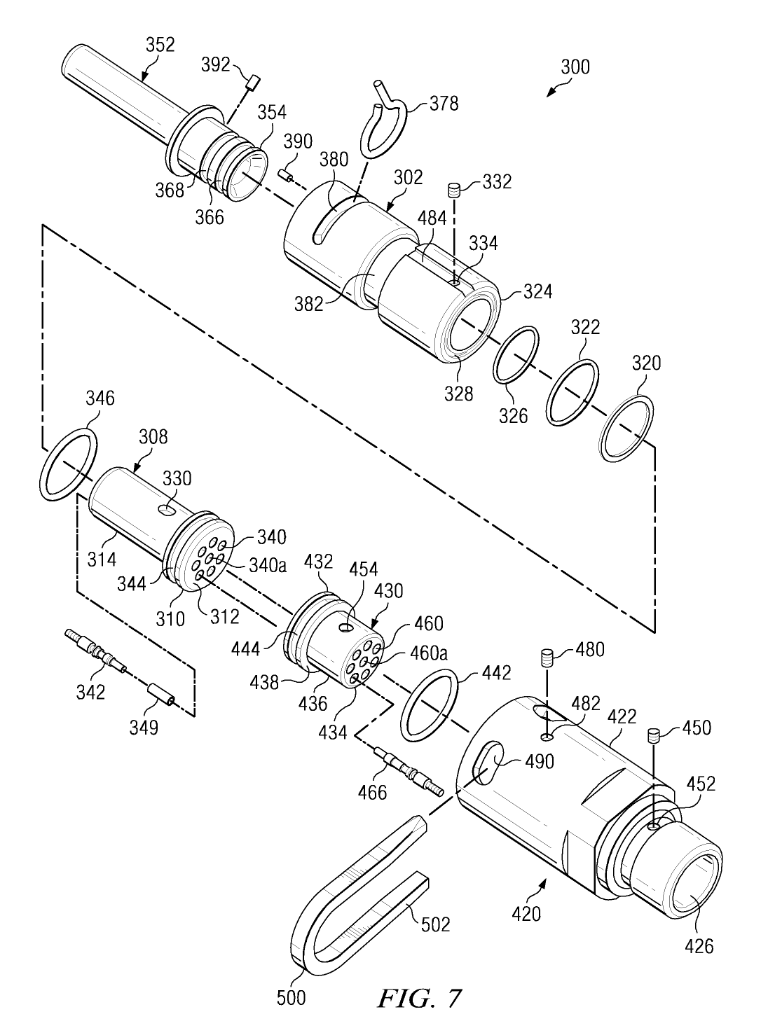

When connector 300 is pushed into receptacle 420, the terminal ends of termini 342 of the connector are pushed against the terminal ends of termini 466 of receptacle 420, forcing termini 466 to move rearwardly, compressing springs 468. Connector 300 and receptacle 420 are aligned for connection by means of a set screw or alignment pin 480 that extends through a hole 482 in wall 422 of socket 424. Pin 480 engages a longitudinally extending slot 484 (FIG. 7) formed in the outside surface of wall 304 of connector 300 to align the connector for coupling with receptacle 420. As connector 300 is inserted into receptacle 420 the terminal ends of termini 466 of socket receptacle 420 are received in captive ceramic split sleeves 349 mounted in termini cavities 340 of plug insert 308 (Note: sleeves 349 are omitted in FIG. 6 for the purpose of illustration). Due to manufacturing variances and/or design, termini 466 may gimbal within cavities 460 over several degrees. Sleeves 349 compensate for such movement, insuring operative alignment of the terminal ends of termini 342 and 466.

Two pair of holes 490 are formed though wall 422 between parallel chords c′ (FIG. 4) that extend substantially perpendicular to a longitudinal axis a′ (FIGS. 4 and 5) of connector 300 and passing through the center of socket 424. When connector 300 is fully inserted in socket 424 such that termini 342 of the connector are in contact with termini 446 of receptacle 420, an annular groove 382, formed in the outside surface of the connector is aligned with holes 490. Holes 490 along with groove 382 form a pair of substantially parallel passageways 492 sized to receive the legs 502 of a substantially U-shaped staple 500. To secure connector 300 in receptacle 420, legs 502 of staple 500 are inserted into holes 490 and staple 500 is driven (e.g. by hammering) to force legs 502 through passageways 492, locking connector 300 in receptacle 420.

When connector 300 is coupled with receptacle 420, the forward face 312 of plug insert 308 meets forward face 434 of socket insert 420 as the connector is pushed into socket 424. Plug insert 308 is forced rearward from its forward or extended position, compressing biasing member 322. The longitudinal travel of plug insert 308 between the extended and compressed position retains plug insert 308 in contact with socket inset 420 with the respective faces 312 and 434 in opposed abutting relationship when tolerances due to manufacturing variations or wear would otherwise permit a space between the faces. The rearward movement of the terminal ends of the optical fibers mounted in plug insert 308 toward the fixed position within the cable guide 352 is accommodated by “S-ing” of the optical fibers within chamber 362.

Plug and socket inserts 308, 420 may be machined from an engineering plastic such as Delrin® rod. However, use of this material and method to form the inserts is relatively expensive and time consuming. Such materials are also prone to creep over a period of time, which may ultimately result in failure of the part.

Attempts to form the inserts from different materials and/or with different methods initially proved unsatisfactory for a variety of reasons. Some materials are too difficult to machine economically while the coefficient of thermal expansion of some materials precluded molding the inserts within acceptable tolerances. It was eventually discovered that plug insert 308 and socket insert 430 could be satisfactorily manufactured from ULTEM® 2300 a fiber-filled polyetherimide containing 30% glass fibers. ULTEM® 2300 has a density of 0.055 lbs/in³ (ASTM-D792), a tensile strength of 17,000 psi (ASTM-D638), a tensile modulus of 800,000 (ASTM-D638), a tensile elongation at break of 3% (ASTM-D638), a compressive strength of 32,000 psi (ASTM-D695), a flexural strength of 30,000 psi (ASTM-D790), a flexural modulus of 900,000 psi (ASTM-D790), a Rockwall hardness of M114/R127 (ASTM-D785) and a coefficient of linear thermal expansion of 1.1×10⁻⁵ in./in.° F. (ASTM-D696). Thus, in one embodiment, inserts according to the disclosure are formed from a glass-filled resin having from about 25% to about 45% glass.

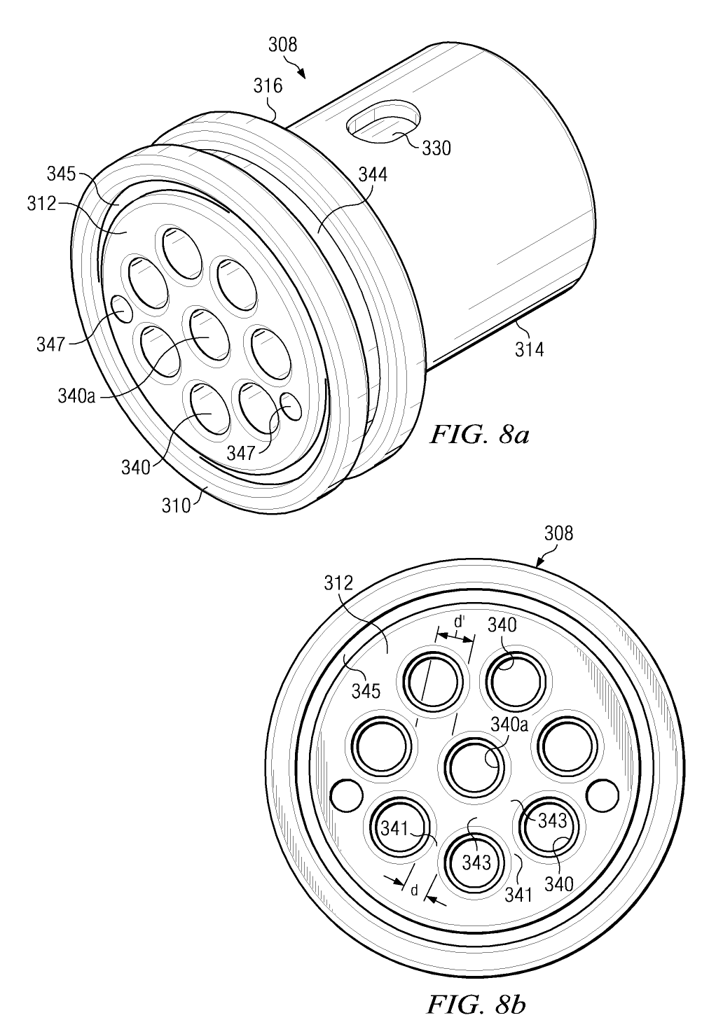

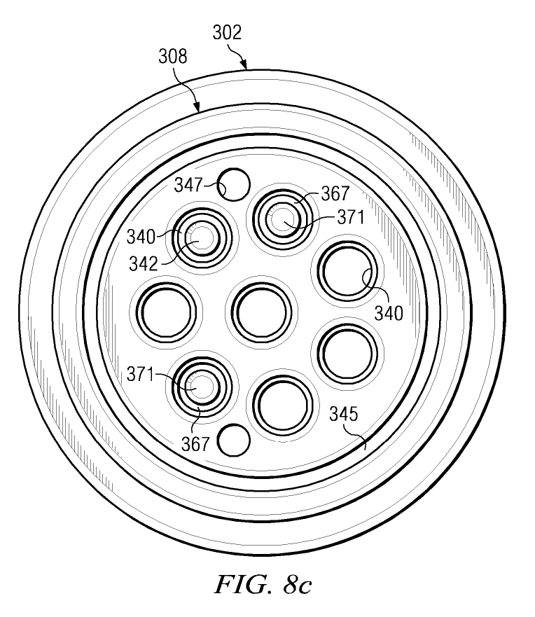

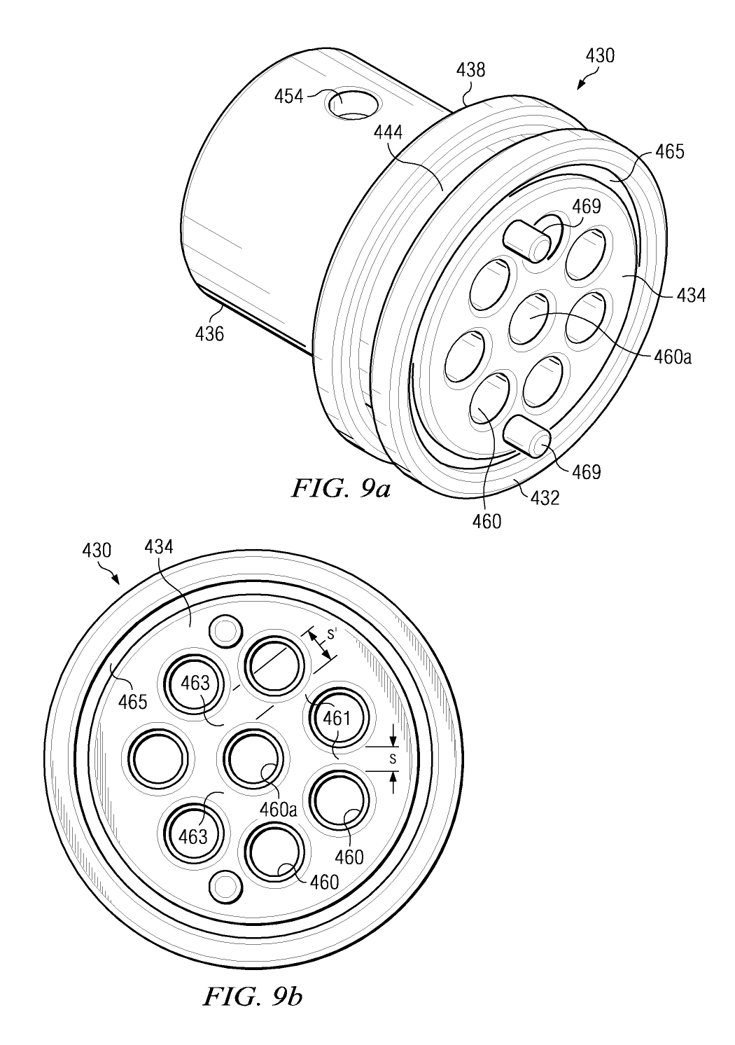

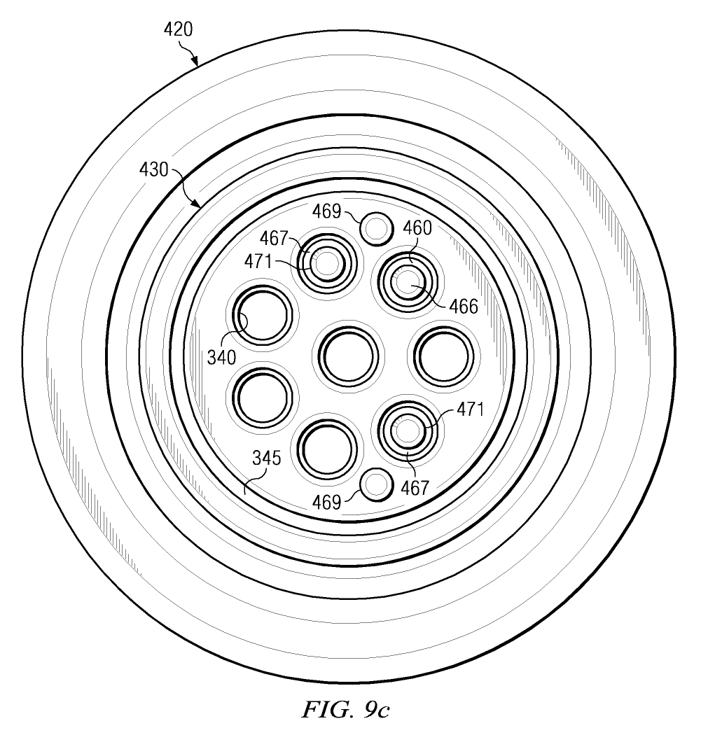

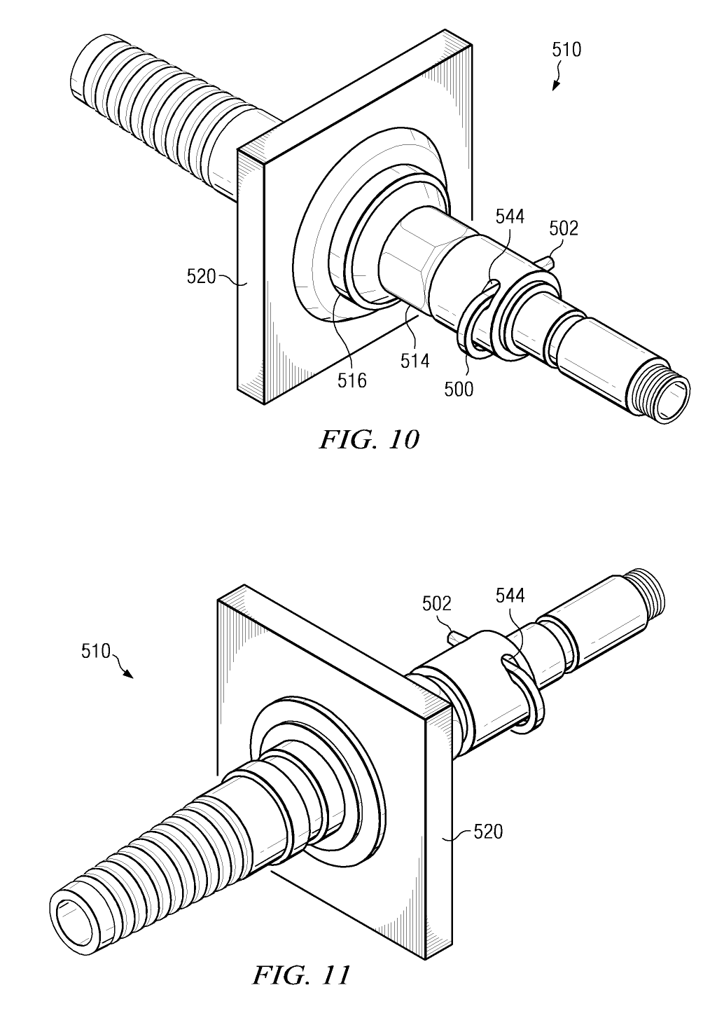

Referring to FIGS. 8a, 8b and 9a, 9b, configuring termini cavities 340, 460 with a uniform minimum wall thickness also facilitates molding of plug and socket inserts 308, 430. In one variation, insert 308 is molded such that the minimum thickness d (FIG. 8b) of walls 341 between adjacent circumferential termini cavities 340 is equal within manufacturing tolerances. Likewise, walls 343 between circumferential cavities 340 and central cavity 340a are formed with a minimum uniform wall thickness d′ substantially equal to the thickness of walls 341. Similarly, socket insert 430 may be formed with walls 461 between adjacent circumferential cavities 460 having the same thickness s (FIG. 9b) as the thickness s′ of walls 463 between the circumferential cavities and the central cavity 460a. Circumferential recesses 345 and 465 in front faces 312, 434 of inserts 308, 430 also facilitate the molding process by reducing the thickness of material adjacent to the respective circumferential cavities.

As best illustrated in FIGS. 8a and 9a, plug insert 308 is formed with a pair of alignment apertures 347 positioned on a chord parallel to and offset from a diameter of face 312. Apertures 347 receive a pair of corresponding alignment pins 469 extending from the face 434 of socket insert 430. The offset position of apertures 347 and pins 469 insure correct alignment of corresponding opposed termini 342, 466 when connector 300 is inserted into receptacle 420.

FIG. 8c shows plug insert 308 positioned in plug body 302 with terminus 342 positioned in termini cavity 340. In the illustrated embodiment, plug insert 308 also includes cavities 367 for receiving an electrical contacts 371. FIG. 9c illustrates socket insert 430 positioned in receptacle 420 with terminus 466 in termini cavity 460. Electrical contacts 471, corresponding to contacts 371 are located in cavities 467. Cavities 367, 467 may have the same or different dimensions as cavities 340, 460 to accommodate electrical contacts 371, 471. In one variation, one or more of contacts 371, 471 comprise a recess and prong, respectively; whereby the prong is received in the recess to establish an electrical connection.

When plug body 302 is inserted into receptacle 420, terminus 342 is brought into mating contact with terminus 466 for transmission of optical signals. Similarly, electrical contacts 371 are brought into contact with contact 471 for transmission of electrical signals and/or electrical power.

Referring to FIGS. 10-12 and 12A, a through-wall connector 510 in accordance with another embodiment includes a receptacle 514 fitted with a collar 516 adapted for mounting in a wall 520 of an enclosure. Collar 516 extends around a large diameter rear portion 518 of receptacle 514 which is adapted to fit within a socket 522 that is affixed (e.g. by welding) to wall 520 around the outer circumference of the wall at corners 524, 526. The connector 510 may be removably secured in socket 522 by means of a clip 523 placed in annular groove 525 in the rear side of collar 516 (protruding through wall 520). In other embodiments, collar 516 may be secured in wall 520 by means of a compression nut, interlocking threads, clips, screws or other fastening means.

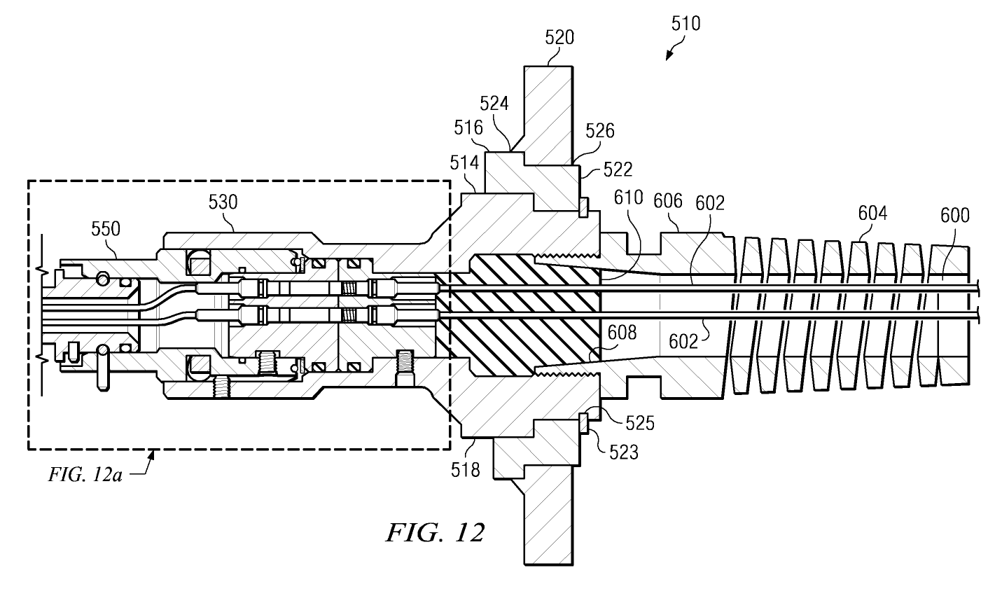

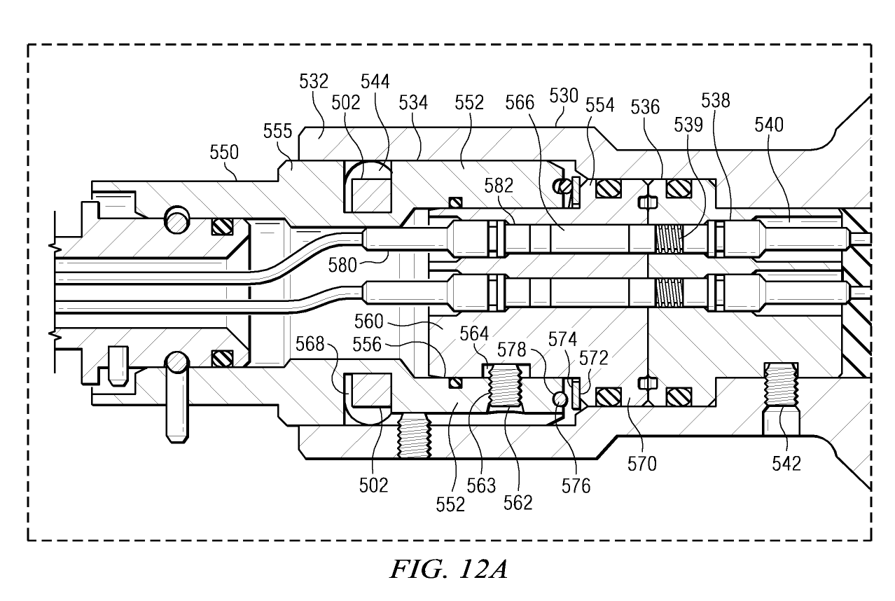

As best illustrated in FIGS. 12 and 12A, receptacle 514 includes a forward socket portion 530 having a cylindrical wall 532 with a passage 534 extending through the receptacle along a central longitudinal axis of socket 530. A socket insert 536, including a plurality of termini 538 mounted in termini cavities 540 is secured in socket 530 with a set screw 542. Termini 538 are biased with springs 539 to permit the termini to travel over a limited, predetermined longitudinal distance to insure operative contact with the mating termini of a corresponding plug or connector. In one embodiment, socket insert 536 and termini 538 are substantially identical to socket insert 430 and termini 466 described above. Socket 530 includes two pair of holes 544 that extend through wall 532 on parallel chords substantially perpendicular to a longitudinal axis of the socket for receiving the legs 502 of staple 500.

A plug 550 including a plug body 552 with a plug insert 554 is inserted in socket 530 of receptacle 514. Plug body 552 includes a generally cylindrical wall 555 defining a central opening 556 for receiving plug insert 554. Plug insert 554 is slidably mounted in plug body 552 and includes a rear portion 560 having a slot 564. A set screw 562 extends though an aperture 563 in plug body engages a slot 564, retaining plug insert 554 in plug body 552. Plug body 552 also includes a groove 568 for receiving legs 502 of staple 500.

A large diameter forward portion 570 of plug insert 554 includes a radially extending rear wall 572 that extends axially between the rear portion 560 and the large diameter forward portion. A bearing washer 574 and a biasing member 576 are positioned between wall 572 and the forward most end of plug body 552. Biasing member 576 is seated in an annular groove 578 in the forward end of plug body 552 whereby member 576 is compressed between bearing washer 574 and the forward end of the plug body. Biasing member 576 may comprise a compression spring such as a Wavo type spring or another known compression springs or resilient compressible member. Biasing member 576 biases plug insert 554 in the forward direction such that the plug insert is slidable relative to plug body 552 between a forward position and rear position. Slot 564 is sufficiently long to permit movement of insert 554 between the forward position and the rearward position when set screw 562 is in place. Biasing member 576 preferably provides a substantially constant biasing force throughout the travel of plug insert 554 between the extended and compressed positions.

A plurality of termini 580 are mounted in termini cavities 582 formed in plug insert 554. Split ceramic sleeves 566 are mounted in cavities 582 to align the forward mating ends of termini 580 and termini 538 of socket 530. In one embodiment, the configuration of plug insert 554 and termini 580 are substantially identical to plug insert 308 and termini 342 described above.

As best shown in FIG. 12 a fiber optic cable 600 having plurality of fiber optic transmission lines 602 extends through a resilient protective boot 604 and fitting 606 into receptacle 514. The terminal ends of the optical fibers are secured in termini 538 mounted in termini cavities 540 of socket insert 536. The annular space 608 between lines 602 and receptacle 524 may be filled with a potting material 610 to secure and protect lines 602 in the receptacle. The forward ends of termini 538 extend beyond the forward end of socket insert 536 into sleeves 566 in mating alignment with termini 580 of plug 550.

When plug 550 is inserted into socket 530, the forward end of plug insert 554 is pushed against the forward end of socket insert 536, forcing plug insert 554 rearward against biasing member 576. The forward ends of termini 538, 580 are forced together, against the biasing force of the termini springs. Groove 568 of plug body 552 moves into alignment with holes 544 of socket 530 and staple 500 is inserted through the holes and groove to secure plug 550 in socket 530.

Termini 538 are spring biased to permit a predetermined amount of longitudinal travel to compensate for manufacturing variances and wear so that the mating ends of the termini will remain in operative contact despite such variances. However, the manufacturing tolerances associated with machining holes 544 and groove 568, along with wear of the holes, groove and staple 500 may exceed the combined predetermined longitudinal travel afforded though the use of spring biased termini 538. The use of slidable plug insert 554 compensates for such variances. In the event of a loose connection between plug 550 and socket 530 after staple 500 is inserted, biasing member 576 forces plug insert 554 to slide forward in plug body 552 to keep the forward end of the plug insert abutted against the forward end of socket insert 536. In this manner, the use of a staple-type connector for coupling fiber optic cables and hybrid cables having both fiber optic and electrical elements is accomplished. Further, biasing member 576 compensates for vibrations that might momentarily separate plug insert 554 from socket insert 536.

The drawings and detailed description herein are to be regarded in an illustrative rather than a restrictive manner, and are not intended to limit the following claims to the particular forms and examples disclosed. On the contrary, further modifications, changes, rearrangements, substitutions, alternatives, design choices, and embodiments will be apparent to those of ordinary skill in the art. Thus, it is intended that the following claims be interpreted to embrace all such further modifications, changes, rearrangements, substitutions, alternatives, design choices, and embodiments.

What is claimed is:

1. A fiber optic connector for mounting to a cable having a plurality of optical fibers and optically connecting the optical fibers to mating optical fibers, wherein the optical fibers and the mating optical fibers have termini mounted to respective ends thereof, and wherein at least one of the termini is slidably mounted and biased to provide a predetermined amount of longitudinal travel during connection, the fiber optic connector comprising:
a plug body having a longitudinal axis, a wall defining a central longitudinal passage, and a groove formed on the outer surface of the wall dimensioned to receive portions of a U-shaped securing staple;
a plug insert having a front face, the plug insert slidably disposed within a first portion of the longitudinal passage for longitudinal movement between an extended position and a compressed position, the insert defining a plurality of termini cavities formed longitudinally through the front face for mounting a plurality of the termini of the optical fibers therein;
a biasing member disposed between the plug body and plug insert for urging the plug insert longitudinally toward the extended position.

2. A fiber optic connector in accordance with claim 1, wherein:
when the end of the plug body proximate to the front face of the plug insert is longitudinally inserted into a receiving cavity of a receptacle body mounting the mating optical fibers in a receptacle insert having a front face until the front face of the plug insert abuts the front face of the receptacle insert;
the plug insert moves longitudinally against the urging of the biasing member to accommodate relative movement between the plug body and the receptacle body while maintaining fixed contact between the front face of the plug insert and the front face of the receptacle insert as the circumferential groove is longitudinally aligned with a plurality of holes formed through the receptacle body and portions of the U-shaped securing staple are inserted through the holes to occupy portions of the groove;
whereby operational contact between the termini of the optical fibers and the mating optical fibers is maintained at a substantially constant force during insertion of the securing staple.

3. A fiber optic connector in accordance with claim 1, wherein the plug insert including the termini cavities is formed by injection molding.

4. A fiber optic connector in accordance with claim 3, wherein the plurality of termini cavities formed longitudinally through the plug insert comprise a single, central termini cavity surrounded by a plurality of circumferentially arranged, equally spaced-apart outer termini cavities.

5. A fiber optic connector in accordance with claim 4, wherein the minimum wall thickness between the central termini cavity and the outer termini cavities is approximately equal to the minimum wall thickness between adjacent outer termini cavities.

6. A fiber optic connector in accordance with claim 3, wherein the plug insert is formed of a glass-filled polymer resin.

7. A fiber optic connector in accordance with claim 6, wherein the glass-filled resin contains from about 25% to about 45% glass.

8. The connector of claim 1 wherein the plug body is formed from a metal.

9. The connector of claim 8 wherein the metal is brass or steel.

10. A fiber optic connector for mounting to a cable having a plurality of optical fibers and optically connecting the optical fibers to mating optical fibers, wherein the optical fibers and the mating optical fibers have termini mounted to respective ends thereof, and wherein at least one of the termini is slidably mounted and biased to provide a predetermined amount of longitudinal travel during connection, the fiber optic connector comprising:
a plug body having a groove formed on the outer surface thereof,
an insert slidably disposed within the plug body, the insert defining a plurality of termini cavities formed longitudinally therethrough for mounting a plurality of the termini of the optical fibers therein;
a biasing member disposed around an outside surface of the insert, the biasing member acting against the plug body to bias the insert toward an extended position; and
wherein the biasing member is compressed upon insertion of the plug body into a receptacle such that the insert is pressed against a corresponding mating insert in the receptacle to maintain contact between termini mounted in the insert and the mating insert when the plug body is secured in the receptacle with a staple extending through the receptacle and the groove.

11. The connector of claim 10 wherein the insert includes a large diameter forward end and a smaller diameter rear end slidably disposed in the plug body.

12. The connector of claim 11 wherein the biasing member is disposed in a groove formed in the forward end of the plug body in opposing relationship with the large diameter forward end of the insert.

13. The connector of claim 10 wherein the biasing member comprises a compression spring.

14. The connector of claim 10 wherein the insert comprises a molded polyimide including a fiber filler.

15. The connector of claim 10 wherein the plug body is formed from a metal.

16. The connector of claim 15 wherein the metal is brass or steel.

17. A connector assembly for a fiber optic connector for mounting to a cable having a plurality of optical fibers and optically connecting the optical fibers to mating optical fibers wherein the optical fibers and mating optical fibers have termini mounted to respective ends thereof, and wherein at least one of the termini is slidably mounted and biased to provide a predetermined amount of longitudinal travel during connection, the assembly comprising:
an insert adapted for slidably mounting in a plug body of the connector and having a plurality of termini cavities extending therethough, the termini cavities being arranged to receive the mating termini of a receptacle;
a biasing member for biasing the insert against the plug body for limited longitudinal movement of the insert between an extended position and a compressed position when the insert is pressed against a surface of a corresponding receptacle; and
wherein the insert moves rearwardly against the force exerted by the biasing member when the insert is pressed against a corresponding mating insert in the receptacle to maintain contact between termini mounted in the insert and in the receptacle.

18. The assembly of claim 17 wherein the insert includes a large diameter forward end and a smaller diameter rear end and wherein the biasing member comprises a compression spring disposed around an outer perimeter of the smaller diameter rear end.

19. The assembly of claim 17 wherein the biasing member is disposed in a groove formed in the forward end of the plug body in opposing relationship with the large diameter forward end of the insert.

20. The assembly of claim 17 further comprising a plurality of sleeves disposed in the termini cavities.

21. The assembly of claim 20 wherein the sleeves are split sleeves formed from a ceramic material.

22. A connector assembly for mounting to a cable having a plurality of optical fibers and optically connecting the optical fibers to mating optical fibers, the assembly comprising:
an insert having a plurality of termini cavities extending therethough, the termini cavities being arranged to receive the mating termini of a fiber optic connector wherein at least one of the mating termini is slidably mounted and biased to provide a predetermined amount of longitudinal travel during connection;
a biasing member extending around an outer perimeter of the insert for biasing the insert for limited longitudinal movement of the insert between an extended position and a compressed position when the insert is pressed against a surface of a corresponding connector;
a plurality of ceramic sleeves disposed in the termini cavity for aligning termini disposed therein with the mating termini; and
wherein the biasing member maintains the insert in contact with a surface of a corresponding connector when the insert is pressed against the corresponding connector to maintain contact between termini mounted in the insert and the mating termini.

23. The assembly of claim 22 wherein the insert comprises a molded polyimide including a fiber filler.

24. The assembly of claim 22, wherein the plurality of termini cavities formed longitudinally through the plug insert comprise a single, central termini cavity surrounded by a plurality of circumferentially arranged, equally spaced-apart outer termini cavities.

25. The assembly of claim 24, wherein the minimum wall thickness between the central termini cavity and the outer termini cavities is approximately equal to the minimum wall thickness between adjacent outer termini cavities.

26. An electrical connector for mounting to a cable having a plurality of electrical conductors and electrically connecting the electrical conductors to mating electrical conductors, wherein the electrical conductors and the mating electrical conductors have contacts mounted to respective ends thereof, the electrical connector comprising:
a generally cylindrical plug body having a longitudinal axis, a wall defining a central longitudinal passage, and a circumferential groove formed on the outer surface of the wall dimensioned to receive portions of a U-shaped securing staple;
a plug insert having a front face, the plug insert longitudinally slidably disposed within a first portion of the longitudinal passage for longitudinal movement between an extended position and a compressed position, the insert defining a plurality of contact cavities formed longitudinally through the front face for mounting a plurality of the contacts of the electrical conductors therein; and
a biasing member disposed between the plug body and plug insert for urging the plug insert longitudinally toward the extended position.

27. The connector of claim 26, wherein:
when the end of the plug body proximate to the front face of the plug insert is longitudinally inserted into a receiving cavity of a receptacle body mounting the mating contacts in a receptacle insert having a front face until the front face of the plug insert abuts the front face of the receptacle insert; and
the plug insert moves longitudinally against the urging of the biasing member to accommodate relative movement between the plug body and the receptacle body while maintaining fixed contact between the front face of the plug insert and the front face of the receptacle insert as the circumferential groove is longitudinally aligned with a plurality of holes formed through the receptacle body and portions of the U-shaped securing staple are inserted through the holes to occupy portions of the groove.

28. The connector of claim 26, wherein the plurality of cavities formed longitudinally through the plug insert comprise a single, central cavity surrounded by a plurality of circumferentially arranged, equally spaced-apart outer cavities.

29. A hybrid connector for mounting to a cable having a plurality of optical fibers and electrical conductors and optically connecting the optical fibers to mating optical fibers and the electrical conductors to mating electrical conductors, wherein the optical fibers and the mating optical fibers have termini mounted to respective ends thereof and wherein the electrical conductors have electrical contacts mounted to the respective ends thereof, and wherein at least one of the termini is slidably mounted and biased to provide a predetermined amount of longitudinal travel during connection, the fiber optic connector comprising:
a plug body;
an insert slidably disposed within the plug body, the insert defining a plurality of cavities formed longitudinally therethrough for mounting at least one of the termini of the optical fibers and at least one of the electrical contacts therein;
a biasing member disposed around an outside surface of the insert, the biasing member acting against the plug body to bias the insert toward an extended position; and
wherein the biasing member is compressed upon insertion of the plug body into a receptacle such that the insert is pressed against a corresponding mating insert in the receptacle to maintain contact between termini mounted in the insert and the mating insert when the plug body is secured in the receptacle.

30. The connector of claim 29 wherein the plug body includes a groove formed on the outer surface thereof, and
wherein the plug body is secured in the receptacle with a staple extending through the receptacle and the groove.

31. The connector of claim 29 wherein the insert includes a large diameter forward end and a smaller diameter rear end slidably disposed in the plug body.

32. The connector of claim 31 wherein the biasing member is disposed in a groove formed in the forward end of the plug body in opposing relationship with the large diameter forward end of the insert.
